(19) United States
(12) Patent Application Publication
(10) Pub. No.: US 2022/0245918 A1
(43) Pub. Date: Aug. 4, 2022

(54) User Equipment and Method of Controlling the Same

(71) Applicants: Hyundai Motor Company, Seoul (KR); Kia Corporation, Seoul (KR)

(72) Inventors: Jae Yul Woo, Seoul (KR); Soobin Kim, Seoul (KR); Seunghyun Woo, Seoul (KR); Rowoon An, Seoul (KR)

(21) Appl. No.: 17/546,379

(22) Filed: Dec. 9, 2021

(30) Foreign Application Priority Data
Feb. 1, 2021 (KR) 10-2021-0014016

(51) Int. Cl. G06V 10/24; G06V 10/25; G06V 10/74; G06V 20/20; G06V 20/64; G06V 20/62; G06V 30/148

(52) U.S. Cl. CPC G06V 10/242; G06V 10/25; G06V 10/761; G06V 30/153; G06V 20/64; G06V 20/63; G06V 20/20

(57) ABSTRACT

An embodiment user equipment (UE) includes a camera, a display configured to display an image captured through the camera, and a controller configured to determine an angle between a plane of a building in which a point of interest (POI) is located and an image capturing direction of the camera, to correct the image corresponding to a feature of the POI with an augmented reality (AR) image which faces directly opposite the image capturing direction of the camera based on the determined angle, and to control the display to display the AR image to be overlaid on the image captured through the camera.

### CROSS-REFERENCE TO RELATED APPLICATIONS

This application claims the benefit of Korean Patent Application No. 10-2021-0014016, filed on Feb. 1, 2021, which application is hereby incorporated herein by reference.

### TECHNICAL FIELD

The disclosure relates to a user equipment (UE) and a method of controlling the same.

### BACKGROUND

Recently, there are increasing services using augmented reality (AR). A user may be provided with an AR service using a user equipment (UE), and may be provided with a more lively service compared to the existing services.

For example, maps and navigation services using AR may display an AR image of a point of interest (POI) of various industries, such as a restaurant, a cafe, and a grocery store, on the location of the POI. That is, when a user captures an image of a POI using a UE, an AR image of the POI may be displayed to be overlaid with the captured image, on an area in which the POI is located.

However, the AR image may be distorted depending on the location and image capturing direction of the UE, and if the AR image for the POI does not exist, the service may not be provided.

### SUMMARY

The disclosure relates to a user equipment (UE) and a method of controlling the same. Particular embodiments relate to a UE for providing an augmented reality (AR) and a method of controlling the same.

Embodiments of the present disclosure provide a UE and a method of controlling the same that are capable of performing image processing so that an AR image of a POI may be displayed to face in direct opposite to an image capturing direction, and allowing a user to participate in updating information about a POI.

Additional embodiments of the disclosure will be set forth in part in the description which follows and, in part, will be obvious from the description, or may be learned by practice of the disclosure.

According to an embodiment of the disclosure, there is provided a user equipment (UE) including a camera, a display configured to display an image captured through the camera, and a controller configured to determine an angle between a plane of a building in which a point of interest (POI) is located and an image capturing direction of the camera, correct an image corresponding to an advertisement of the POI with an augmented reality (AR) image which faces to be in direct opposite to the image capturing direction of the camera based on the determined angle, and control the display to display the AR image to be overlaid on the image captured through the camera.

The UE may further include a communicator configured to perform communication with a server, wherein the controller may be configured to compare the AR image with identification information of the POI received from the server, and if a similarity between the AR image and the identification information is greater than or equal to a predetermined value, control the display to display the AR image.

The controller may be configured to control the display to display the AR image on a location in which the advertisement is located in the image captured through the camera.

The controller may be configured to control the display to display an AR icon indicating an industry of the POI in a location adjacent to the location in which the AR image is displayed.

The controller may be configured to perform plane detection on the image captured through the camera to detect the plane of the building in which the POI is located.

The controller may be configured to rotate the image corresponding to the advertisement of the POI by the determined angle with respect to a vertical axis, to correct the image corresponding to the advertisement of the POI with the AR image which faces in direct opposite to the image capturing direction of the camera.

The controller may be configured to, if the identification information of the POI is not received from the server or has a user evaluation score less than a predetermined value, determine the identification information of the POI.

The controller may be configured to determine the identification information of the POI to include the AR image, and control the communicator to transmit the determined identification information to the server.

The controller may be configured to determine a business name of the POI by performing optical character recognition (OCR) on the image corresponding to the advertisement, determine the identification information of the POI to include the determined business name, and control the communicator to transmit the determined identification information to the server.

The UE may further include an inputter configured to receive a user input, wherein the controller may be configured to, upon receiving location information of the POI through the inputter, determine the identification information of the POI to include the location information and control the communicator to transmit the determined identification information to the server.

According to another embodiment of the disclosure, there is provided a method of controlling a user equipment (UE) including a camera and a display, the method including determining an angle between a plane of a building in which a point of interest (POI) is located and an image capturing direction of the camera, correcting an image corresponding to an advertisement of the POI with an augmented reality (AR) image which faces in direct opposite to the image capturing direction of the camera based on the determined angle, and controlling the display to display the AR image to be overlaid on the image captured through the camera.

The UE may further include a communicator configured to perform communication with a server, and the method may further include comparing the AR image with identification information of the POI received from the server, and if a similarity between the AR image and the identification information is greater than or equal to a predetermined value, controlling the display to display the AR image.

The controlling of the display may include controlling the display to display the AR image on a location in which the advertisement is located in the image captured through the camera.

The method may further include controlling the display to display an AR icon indicating an industry of the POI in a location adjacent to the location in which the AR image is displayed.

The method may further include performing plane detection on the image captured through the camera to detect the plane of the building in which the POI is located.

The correcting of the image corresponding to the advertisement of the POI with the AR image may include rotating the image corresponding to the advertisement of the POI by the determined angle with respect to a vertical axis, to correct the image corresponding to the advertisement of the POI with the AR image which faces in direct opposite to the image capturing direction of the camera.

The method may further include, if the identification information of the POI is not received from the server or has a user evaluation score less than a predetermined value, determining the identification information of the POI.

The method may further include determining the identification information of the POI to include the AR image, and controlling the communicator to transmit the determined identification information to the server.

The method may further include determining a business name of the POI by performing optical character recognition (OCR) on the image corresponding to the advertisement, determining the identification information of the POI to include the determined business name, and controlling the communicator to transmit the determined identification information to the server.

The UE may further include an inputter configured to receive a user input, wherein the method may further include, upon receiving location information of the POI through the inputter, determining the identification information of the POI to include the location information, and controlling the communicator to transmit the determined identification information to the server.

### BRIEF DESCRIPTION OF THE DRAWINGS

These and/or other embodiments of the disclosure will become apparent and more readily appreciated from the following description of exemplary embodiments, taken in conjunction with the accompanying drawings, in which:

FIG. 1 is a diagram illustrating a system for displaying a POI according to an embodiment;

FIG. 2 is a control block diagram illustrating a UE according to an embodiment;

FIG. 3 is a diagram illustrating a case in which a UE captures an image of a POI according to an embodiment;

FIG. 4 is a diagram illustrating a case in which a UE determines an angle between a plane of a building in which a POI is located and an image capturing direction of a camera according to an embodiment;

FIG. 5 is a diagram for describing a case in which a UE corrects an image corresponding to a feature, e.g., an advertisement, in a POI using an AR image according to an embodiment;

FIG. 6 is a diagram for describing a case in which a UE compares an AR image with identification information according to an embodiment;

FIG. 7 is a diagram illustrating a case in which a UE displays an AR image according to an embodiment;

FIG. 8 is a diagram illustrating a case in which a UE determines identification information of a POI according to an embodiment;

FIG. 9 is a flowchart showing a method of controlling a UE according to an embodiment, which shows a case of displaying an AR image; and

FIG. 10 is a flowchart showing a method of controlling a UE according to an embodiment, which shows a case of determining identification information of a POI.

### DETAILED DESCRIPTION OF ILLUSTRATIVE EMBODIMENTS

Like numerals refer to like elements throughout the specification. Not all elements of embodiments of the present disclosure will be described, and descriptions of what are commonly known in the art or what overlap each other in the embodiments will be omitted.

It will be further understood that the term “connect” or its derivatives refer both to direct and indirect connection, and the indirect connection includes a connection over a wireless communication network.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof, unless the context clearly indicates otherwise.

As used herein, the singular forms “a,” “an” and “the” are intended to include the plural forms as well, unless the context clearly indicates otherwise.

The terms, such as “˜part”, “˜device”, “˜block”, “˜member”, “˜module”, and the like may refer to a unit for processing at least one function or act. For example, the terms may refer to at least one process processed by at least one hardware, such as a field-programmable gate array (FPGA)/application specific integrated circuit (ASIC), software stored in memories, or processors.

Reference numerals used for method operations are just used to distinguish each operation, but not to limit an order of the operations. Thus, unless the context clearly dictates otherwise, the written order may be practiced otherwise.

Hereinafter, embodiments of a UE and a method of controlling the same will be described in detail with reference to the accompanying drawings.

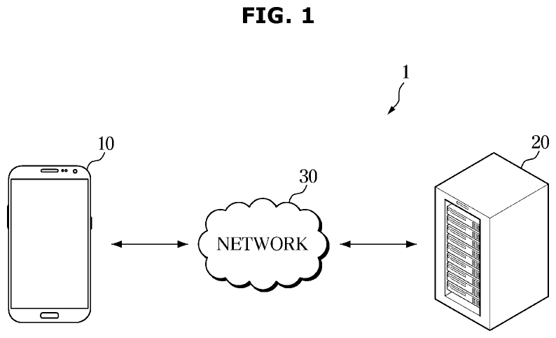

FIG. 1 is a diagram illustrating a system for displaying a point of interest (POI) according to an embodiment.

Referring to FIG. 1, a system 1 for displaying a POI includes a user equipment (UE) 10 for displaying an augmented reality (AR) image of a POI, a server 20 for managing identification information for each POI, and a network 30 for providing communication between the UE 10 and the server 20.

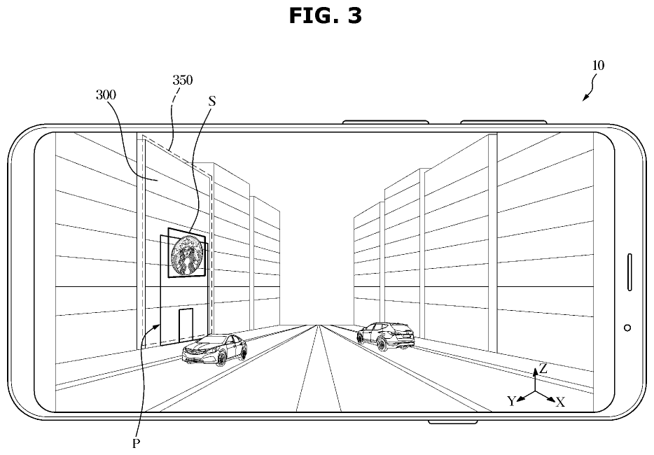

In this case, the POI P (see, e.g., FIG. 3) may correspond to shops of various industries, such as restaurants, cafes, and grocery stores. However, the type of POIs P is not limited to a shop, and may represent other places, such as a tourist destination or a government office. Hereinafter, for the sake of convenience of description, the POI P will be described as a café as an example.

In addition, the identification information may represent information for identifying a POI, and may include location information of the POI, a business name of the POI, an advertisement (a logo, a signboard, etc.) of the POI, etc.

The UE 10 according to the embodiment may display an AR image of a POI located in an image capturing direction of a camera on the display.

That is, the UE 10 may determine a POI located in an image capturing direction of the camera based on location information of the UE 10 and location information of the POI included in the identification information for each POI, correct an image corresponding to an advertisement of the POI with an AR image that faces in direct opposite to the image capturing direction of the camera, and display the AR image to be overlaid on the image captured through the camera.

The UE 10 may compare the corrected AR image with images included in the identification information of the POI and display the corrected AR image when the similarity is greater than or equal to a predetermined value.

The UE 10 according to the embodiment may, if the identification information of the POI does not exist or has a user evaluation score less than a predetermined value, determine the identification information of the POI, and transmit the determined identification information to the server 20 such that the identification information for each POI may be updated.

In this case, the UE 10 may determine the identification information of the POI to include the corrected AR image.

In addition, the UE 10 may determine the business name of the POI by performing optical character recognition (OCR) on the image corresponding to the advertisement, and determine the identification information of the POI to include the determined business name.

In addition, the UE 10 may determine the identification information of the POI to include location information of the POI acquired through a user input.

The server 20 may, upon receiving the identification information of the POI from the UE 10, add the received identification information of the POI to a database including the identification information for each POI, to update the database. The updated database may be shared with the UE 10 subscribed to the service through the network 30.

In addition, the server 20 may provide the user of the UE 10, who has determined and transmitted identification information of the POI, with a reward (e.g., points, coins, cash, authentication, ranking, etc.).

In the above, the system 1 for displaying a POI has been described. Hereinafter, each component of the UE 10 will be described in detail.

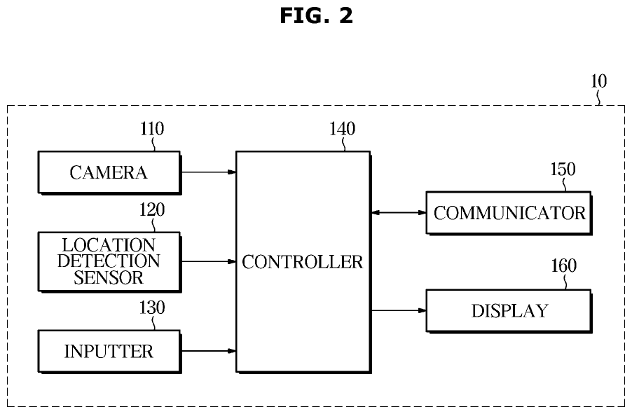

FIG. 2 is a control block diagram illustrating a UE 10 according to an embodiment.

Referring to FIG. 2, a UE 10 according to the embodiment includes a camera 110, a location detection sensor 120 for detecting the location of the UE 10, an inputter 130 for receiving a user input, a controller 140 for determining identification information of a POI and generating and displaying an AR image of a POI, a communicator 150 for performing communication with the server 20, and a display 160.

The camera 110 according to the embodiment may be provided on the front and/or rear of the UE 10 to acquire an image. The camera 110 may be provided as an image sensor of a known type, and there is no limitation on the type of the camera.

The location detection sensor 120 according to the embodiment may detect the location of the UE 10. For example, the location detection sensor 120 may determine the location of the UE 10 by receiving a global positioning system (GPS) signal. In addition, the location detection sensor 120 may detect an image capturing direction of the camera 110 by detecting a direction, an inclination, etc. of the UE 10.

The inputter 130 according to the embodiment may be configured to receive a user input and may be provided as a known type of input device. For example, the inputter 130 may be implemented in the form of a touch screen integrally formed with the display 160.

The controller 140 according to the embodiment may control the display 160 to display an AR image of a POI located in an image capturing direction of the camera 110.

Specifically, the controller 140 may correct an image corresponding to an advertisement in a POI with an AR image that faces in direct opposite to the image capturing direction of the camera 110, and control the display 160 to display the AR image to be overlaid on the image captured through the camera 110.

In addition, according to the embodiment, the controller 140 may compare the corrected AR image with images included in the identification information of the POI received from the server 20, and when the similarity is greater than or equal to a predetermined value, display the corrected AR image.

Displaying the AR image of the POI will be described in detail below.

The controller 140 according to the embodiment may, if identification information of the POI does not exist or has a user evaluation score less than a predetermined value, determine the identification information of the POI and control the communicator 150 to transmit the determined identification information to the server 20.

In this case, the controller 140 may determine the identification information of the POI to include the corrected AR image.

In addition, the controller 140 may determine the business name of the POI by performing OCR on the image corresponding to the advertisement, and determine the identification information of the POI to include the determined business name.

In addition, the controller 140 may determine the identification information of the POI to include location information of the POI acquired through a user input.

Determining the identification information of the POI and transmitting the determined identification information to the server 20 will be described in detail below.

The controller 140 may include at least one memory in which a program for performing the above-described operation and an operation to be described below is stored, and at least one processor for executing the stored program. When the memory and the processor are each provided in plural, the plurality of memories and processors may be integrated on a single chip or may be provided in physically separate locations.

The communicator 150 according to the embodiment may perform communication with the server 20, and may receive identification information for each POI from the server 20 or transmit identification information of a POI. The communicator 150 may be provided as a wireless communication module in a known type.

The display 160 according to the embodiment may be provided on the front of the UE 10 to display an image captured through the camera 110, and may display an AR image to be overlaid on the image captured through the camera 110. To this end, the display 160 may be provided as a display module in a known type, and as described above, may be implemented as a touch screen integrally formed with the inputter 130.

In the above, each component of the UE 10 has been described in detail. Hereinafter, the displaying of an AR image of a POI will be described in detail.

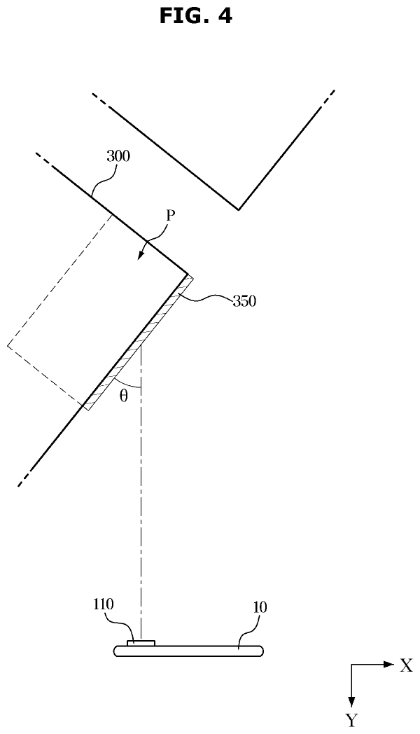

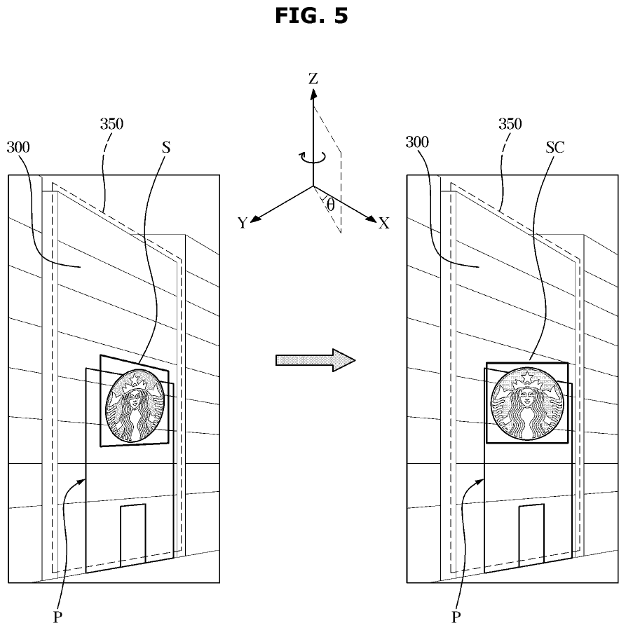

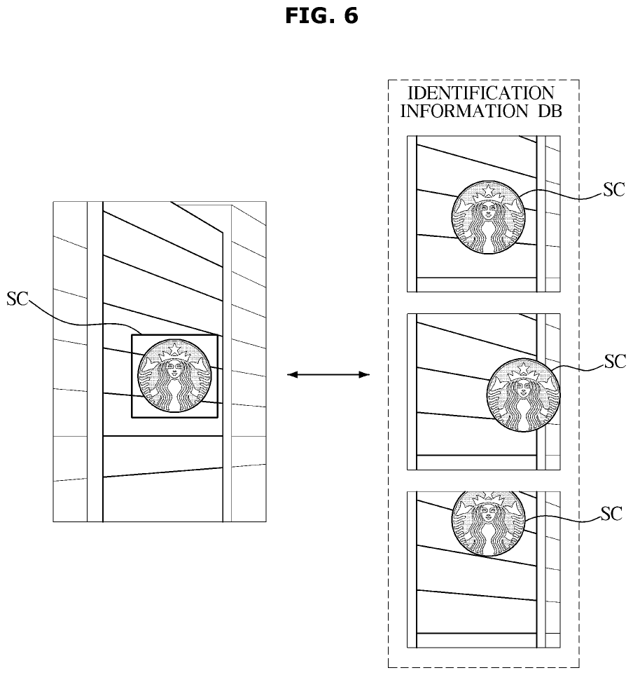

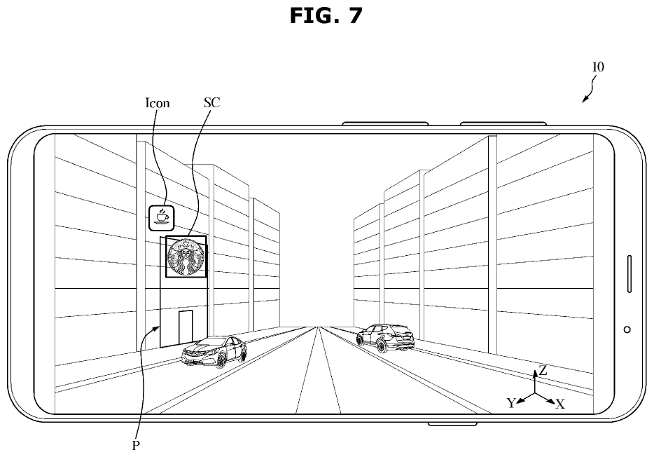

FIG. 3 is a diagram illustrating a case in which a UE 10 captures an image of a POI according to an embodiment, FIG. 4 is a diagram illustrating a case in which a UE 10 determines an angle between a plane of a building in which a POI is located and an image capturing direction of a camera according to an embodiment, FIG. 5 is a diagram for describing a case in which a UE 10 corrects an image corresponding to an advertisement of a POI with an AR image according to an embodiment, FIG. 6 is a diagram for describing a case in which a UE 10 compares an AR image with identification information according to an embodiment, and FIG. 7 is a diagram illustrating a case in which a UE 10 displays an AR image according to an embodiment.

Referring to FIGS. 3 and 4, the UE 10 according to the embodiment may, when capturing an image of a POI P through the camera 110, display an AR image corresponding to the POI P on the display 160.

In this case, the POI P may correspond to shops of various industries, such as restaurants, cafes, and grocery stores. However, the type of POI P is not limited to a shop, and there is no limitation, and may represent other places, such as a tourist destination or a government office. Hereinafter, for the sake of convenience of description, the POI P will be described as a café as an example.

Specifically, the UE 10 may receive identification information for each POI including location information of the POI P from the server 20 and store the received identification information, and may identify the POI P located in the image capturing direction of the camera 110 based on the location information of the POI P and location information of the UE 10.

The UE 10 may, upon the POI P being identified, initiate an operation of converting an image S corresponding to an advertisement of the POI P into an AR image.

The UE 10, according to an embodiment, may be configured to, if the distance between the POI P and the UE 10 is less than a predetermined distance, identify the POI P and initiate the operation of converting the image S corresponding to the advertisement of the POI P.

Referring to FIG. 4, the UE 10, in order to convert the image S into an AR image that faces in direct opposite to the image capturing direction of the camera 110, may determine an angle θ between a plane 350 of a building 300 in which the POI P is located and the image capturing direction of the camera 110. The plane 350 may correspond to a surface on which the advertisement of the POI P is attached.

In this case, the UE 10 may determine the plane 350 of the building 300 in which the POI P is located by performing plane detection on the image captured through the camera 110.

The UE 10 may correct the image S corresponding to the advertisement of the POI P into the AR image that faces in direct opposite to the image capturing direction of the camera 110 based on the determined angle θ.

That is, referring to FIG. 5, the UE 10 may rotate the image S corresponding to the advertisement of the POI P by the determined angle θ with respect to the vertical axis (z axis) to correct the image S into an AR image SC that faces in direct opposite to the image capturing direction of the camera 110.

The UE 10 may display the AR image SC to be overlaid on the image captured through the camera 110. In this case, since the AR image SC is displayed in direct opposite to the image capturing direction of the camera 110, the user may be provided with an advertisement image without distortion regardless of the image capturing direction of the camera 110.

In addition, the UE 10, according to an embodiment, may compare the AR image SC with the identification information of the POI P received from the server 20, and if the similarity between the AR image SC and the identification information is greater than or equal to a predetermined value, display the AR image SC.

Specifically, referring to FIG. 6, the UE 10 may determine the similarity by comparing the AR image SC with advertisement images included in a database of identification information, and if the similarity is greater than or equal to the predetermined value, display the AR image SC. In this case, the advertisement images included in the identification information of the POI P may be advertisement images uploaded by a service provider or another user and stored therein.

Referring to FIG. 7, the UE 10 may display the AR image SC at a location in which the advertisement is located in the image captured through the camera 110. That is, the UE 10 may display the AR image SC corresponding to the advertisement image in an area in which the actual advertisement is located in the image captured through the camera 110. By the AR image SC located at a more accurate position, the user may more accurately recognize the POI P.

In addition, referring to FIG. 7, the UE 10, according to an embodiment, may display an AR icon indicating the industry of the POI P in a location adjacent to the location in which the AR image SC is displayed.

In the above, the displaying of the AR image SC of the POI P has been described in detail. Hereinafter, determining identification information of the POI and transmitting the determined identification information to the server 20 will be described in detail.

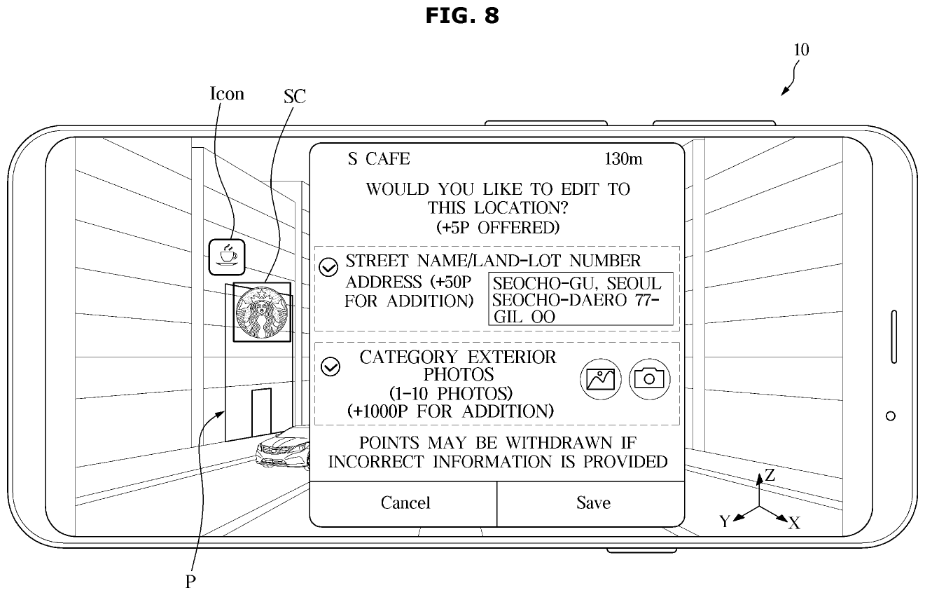

FIG. 8 is a diagram illustrating a case in which a UE 10 determines identification information of a POI according to an embodiment.

Referring to FIG. 8, the UE 10 according to the embodiment may be configured to, if identification information of the POI P does not exist (identification information of the POI P is not received), or has a user evaluation score less than a predetermined value, determine the identification information of the POI P, and transmit the determined identification information to the server 20.

Specifically, referring to FIG. 8, the UE 10 may receive location information (road name/land-lot address) of the POI P from the user, and may determine identification information of the POI P to include the location information, and transmit the determined identification information to the server 20.

In addition, referring to FIG. 8, the UE 10, when receiving an input for uploading a photo (a category exterior photo) of the POI P from the user, may correct an image corresponding to an advertisement among the uploaded photos into an AR image that faces in direct opposite to the image capturing direction of the camera 110, determine identification information of the POI P to include the AR image, and transmit the determined identification information to the server 20.

In addition, referring to FIG. 8, the UE 10, when receiving an input for uploading a photo (a category exterior photo) of the POI P from the user, may perform OCR on an image corresponding to an advertisement among the uploaded photos to determine the business name of the POI P, determine identification information of the POI P to include the business name, and transmit the determined identification information to the server 20.

The server 20, upon receiving the identification information of the POI P from the UE 10, may add the received identification information of the POI P to the database including identification information for each POI so that the database may be updated, and the updated database may be shared with the UE 10 subscribed to the service through the network 30.

In addition, the server 20 may provide a user of the UE 10 who has determined and transmitted identification information of the POI with a reward (e.g., points, coins, cash, authentication, ranking, etc.).

As described above, users may participate in the construction of a database including identification information for each POI, so that the POIs provided by the system for displaying a POI may be expanded and the accuracy of location information and an AR image of the POI may be increased.

Hereinafter, an embodiment of a method of controlling the UE 10 will be described. The UE 10 according to the above-described embodiment may be used for the method of controlling the UE 10. Accordingly, the contents described above with reference to FIGS. 1 to 8 may be equally applied to the method of controlling the UE 10.

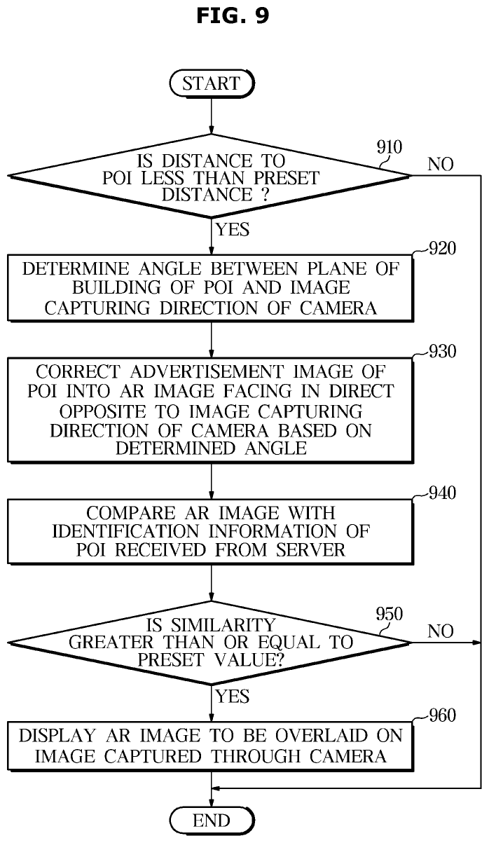

FIG. 9 is a flowchart showing a method of controlling a UE 10 according to an embodiment, which shows a case of displaying an AR image.

Referring to FIG. 9, the UE 10 according to the embodiment may be configured to, if the distance to the POI P is less than a predetermined distance (YES in operation 910), determine an angle θ between the plane 350 of the building 300 in which the POI P is located and the image capturing direction of the camera 110 (920).

In this case, the UE 10 may determine the plane 350 of the building 300 in which the POI P is located by performing plane detection on the image captured through the camera 110. The plane 350 may correspond to a surface of the building 300 to which an advertisement of the POI P is attached.

The UE 10 may correct an advertisement image S of the POI P into an AR image SC that faces in direct opposite to the image capturing direction of the camera 110 based on the determined angle θ (930).

That is, the UE 10 may rotate the image S corresponding to the advertisement of the POI P by the determined angle θ with respect to the vertical axis (z axis) to thereby correct the image S into an AR image SC that faces in direct opposite to the image capturing direction of the camera 110.

The UE 10 compares the AR image SC with identification information of the POI P received from the server 20 (940), and if the similarity is greater than or equal to a predetermined value (YES in operation 950), display the AR image SC to be overlaid on the image captured through the camera 110 (960).

Specifically, the UE 10 may determine the similarity by comparing the AR image SC with advertisement images included in the database of identification information, and when the similarity is greater than or equal to a predetermined value, display the AR image SC. In this case, the advertisement images included in the identification information of the POI P may be advertisement images uploaded by a service provider or another user and stored therein.

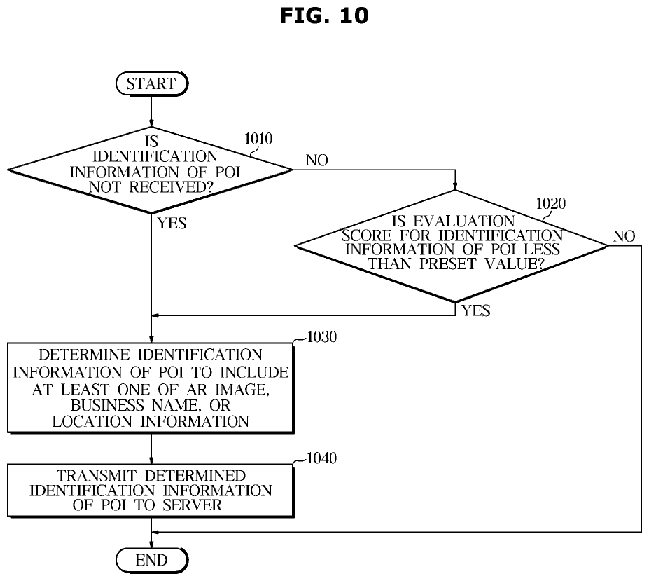

FIG. 10 is a flowchart showing a method of controlling a UE 10 according to an embodiment, which shows a case of determining identification information of a POI.

Referring to FIG. 10, the UE 10 according to the embodiment may be configured to, if the identification information of the POI P is not received (YES in operation 1010), or has an evaluation score less than a predetermined value (YES in operation 1020), determine identification information of the POI P including at least one of the AR image SC, the business name, or the location information (1030), and transmit the determined identification information of the POI P to the server 20 (1040).

Specifically, the UE 10 may be configured to, upon receiving location information (road name/land-lot address) of the POI P from the user, determine identification information of the POI P to include the location information, and transmit the determined identification information to the server 20.

The UE 10, when receiving an input for uploading a photo (a category exterior photo) of the POI P from the user, may correct an image corresponding to an advertisement among the uploaded photos into an AR image that faces in direct opposite to the image capturing direction of the camera 110, determine identification information of the POI P to include the AR image, and transmit the determined identification information to the server 20.

In addition, the UE 10, when receiving an input for uploading a photo (a category exterior photo) of the POI P from the user, may perform OCR on an image corresponding to an advertisement among the uploaded photos to determine the business name of the POI P, determine the identification information of the POI P to include the business name, and transmit the determined identification information to the server 20.

The server 20, upon receiving the identification information of the POI P from the UE 10, may add the received identification information of the POI P to the database including identification information for each POI so that the database may be updated, and the updated database may be shared with the UE 10 subscribed to the service through the network 30.

In addition, the server 20 may provide a user of the UE 10 who has determined and transmitted identification information of the POI with a reward (e.g., points, coins, cash, authentication, ranking, etc.).

Meanwhile, the disclosed embodiments may be embodied in the form of a recording medium storing instructions executable by a computer. The instructions may be stored in the form of program code and, when executed by a processor, may generate a program module to perform the operations of the disclosed embodiments. The recording medium may be embodied as a computer-readable recording medium.

The computer-readable recording medium includes all kinds of recording media in which instructions which may be decoded by a computer are stored, for example, a Read Only Memory (ROM), a Random Access Memory (RAM), a magnetic tape, a magnetic disk, a flash memory, an optical data storage device, and the like.

As is apparent from the above, the UE and the method of controlling the same according to embodiments can provide an AR image without a distortion and improve the accuracy of information about a POI by performing image processing such that an AR image of a POI is displayed to face in direct opposite to an image capturing direction, and by allowing a user to participate in updating information about the POI.

Although embodiments of the present disclosure have been described for illustrative purposes, those skilled in the art will appreciate that various modifications, additions and substitutions are possible, without departing from the scope and spirit of the disclosure.

What is claimed is:

1. A user equipment (UE) comprising:
a camera;
a display configured to display an image captured through the camera; and
a controller configured to:
determine an angle between a plane of a building in which a point of interest (POI) is located and an image capturing direction of the camera;
correct an image corresponding to a feature of the POI with an augmented reality (AR) image which faces directly opposite the image capturing direction of the camera based on the determined angle; and
control the display to display the AR image to be overlaid on the image captured through the camera.

2. The UE of claim 1, further comprising a communicator configured to perform communication with a server, wherein the controller is configured to:
compare the AR image with identification information of the POI received from the server; and
if a similarity between the AR image and the identification information is greater than or equal to a predetermined value, control the display to display the AR image.

3. The UE of claim 2, wherein the controller is configured to control the display to display the AR image on a location in which the feature is located in the image captured through the camera.

4. The UE of claim 3, wherein the controller is configured to control the display to display an AR icon indicating an industry of the POI in a location adjacent to the location in which the AR image is displayed.

5. The UE of claim 2, wherein the controller is configured to determine the identification information of the POI in response to the identification information of the POI not being received from the server or the identification information of the POI having a user evaluation score less than a predetermined value.

6. The UE of claim 5, wherein the controller is configured to:
determine the identification information of the POI to include the AR image; and
control the communicator to transmit the determined identification information to the server.

7. The UE of claim 5, further comprising an inputter configured to receive a user input, wherein the controller is configured to, in response to receiving location information of the POI through the inputter, determine the identification information of the POI to include the location information and control the communicator to transmit the determined identification information to the server.

8. The UE of claim 2, wherein the controller is configured to:
determine a business name of the POI by performing optical character recognition (OCR) on the image corresponding to the feature;
determine the identification information of the POI to include the determined business name; and
control the communicator to transmit the determined identification information to the server.

9. The UE of claim 1, wherein the controller is configured to perform plane detection on the image captured through the camera to detect the plane of the building in which the POI is located.

10. The UE of claim 1, wherein the controller is configured to rotate the image corresponding to the feature of the POI by the determined angle with respect to a vertical axis to correct the image corresponding to the feature of the POI with the AR image facing directly opposite the image capturing direction of the camera.

11. A method of controlling a user equipment (UE) including a camera and a display, the method comprising:
determining an angle between a plane of a building in which a point of interest (POI) is located and an image capturing direction of the camera;
correcting an image corresponding to a feature of the POI with an augmented reality (AR) image facing directly opposite the image capturing direction of the camera based on the determined angle; and
controlling the display to display the AR image to be overlaid on an image captured through the camera.

12. The method of claim 11, wherein the method further comprises:
comparing the AR image with identification information of the POI received from a server; and
in response to a similarity between the AR image and the identification information being greater than or equal to a predetermined value, controlling the display to display the AR image.

13. The method of claim 12, wherein controlling the display includes controlling the display to display the AR image on a location in which the feature is located in the image captured through the camera.

14. The method of claim 13, further comprising controlling the display to display an AR icon indicating an industry of the POI in a location adjacent to the location in which the AR image is displayed.

15. The method of claim 11, further comprising performing plane detection on the image captured through the camera to detect the plane of the building in which the POI is located.

16. The method of claim 11, wherein correcting the image corresponding to the feature of the POI with the AR image comprises rotating the image corresponding to the feature of the POI by the determined angle with respect to a vertical axis to correct the image corresponding to the feature of the POI with the AR image facing directly opposite the image capturing direction of the camera.

17. The method of claim 12, further comprising:
in response to the identification information of the POI not being received from the server or the identification information of the POI having a user evaluation score less than a predetermined value, determining the identification information of the POI.

18. The method of claim 17, further comprising:
determining the identification information of the POI to include the AR image; and
controlling a communicator to transmit the determined identification information to the server.

19. The method of claim 17, further comprising:
determining a business name of the POI by performing optical character recognition (OCR) on the image corresponding to the feature;
determining the identification information of the POI to include the determined business name; and
controlling a communicator to transmit the determined identification information to the server.

20. The method of claim 17, further comprising:
in response to receiving location information of the POI through an inputter, determining the identification information of the POI to include the location information; and
controlling a communicator to transmit the determined identification information to the server.
